(19) United States
(12) Patent Application Publication
(10) Pub. No.: US 2002/0010759 A1
(43) Pub. Date: Jan. 24, 2002

(54) System and method for multimedia content composition and distribution

(76) Inventors: Bruce L. Hitson, Raleigh, NC (US); Paul B. Mayer, Durham, NC (US); Jeffrey L. Williams, Cary, NC (US)

Correspondence Address: GREENBERG-TRAURIG, 1750 TYSONS BOULEVARD, 12TH FLOOR, MCLEAN, VA, 22102, US

(21) Appl. No.: 09/749,633

(22) Filed: Dec. 28, 2000

Related U.S. Application Data
(60) Provisional application No. 60/173,800, filed on Dec. 30, 1999.

(51) Int. Cl. G06F 15/16

(52) U.S. Cl. 709/219

(57) ABSTRACT

A system and method are disclosed which allows multimedia content to be delivered to a computer, personal desktop assistant, portable media player, or other electronic device. Such content may include advertisements, and distribution of content may emulate current television and/or radio broadcasts. Content may be encrypted or otherwise secured, and such security may restrict use of some content; examples of such restrictions may include limiting content to specific devices, specific users, or a predefined number of playbacks. Users of the present invention may also indicate a preference for a particular content type or types, and content may be chosen by the present invention based on user preferences. Users may further refine content preferences as content is experienced, thus providing a more enjoyable experience. Users of the present invention may indicate a desire to purchase content or find out more about specific content, and such desires may be recorded for later review or action.

### PRIORITY CLAIM

The present invention claims priority from U.S. Provisional Patent Application No. 60/173,800, filed Dec. 30, 1999, the contents of which, including all Appendices and Figures, are incorporated herein by reference.

### FIELD OF THE INVENTION

The present invention relates to the composition and distribution of multimedia files. In particular, the present invention provides a system and method for composing and delivering music and other audio content via the Internet.

### BACKGROUND OF THE INVENTION

The Internet has revolutionized the creation and distribution of almost every form of media today. New technologies are constantly being developed which allow producers to digitally record high quality versions of audio and video signals, compress the recorded signals (either while recording is taking place or after the fact), and deliver the content to a user terminal, personal computer, network computer, workstation, server, kiosk, paging device, cellular or other telephone, or other electronic or computerized device (“PC” collectively) via high-speed networks such as the Internet. In addition, specialized devices are being developed which can be attached to a PC and allow customers to experience content when away from a PC. Three of the most interesting of these recent developments are MPEG-1 Audio Layer-3 (“MP3”) files, Advanced Streaming Format Windows Media Audio (WMA) files, and portable media players (“PMP”).

MP3 uses a sampling and compression method that creates audio files almost 12 times smaller than those created by traditional sampling methods, thereby significantly reducing the storage requirements for audio files. WMA files use a different sampling and compression method, and the WMA algorithm creates a file half the size of an MP3 file while still preserving high-fidelity sound.

A PMP is a device that can communicate with a computer or hook directly to the Internet through a wireless or wired modem or network card. Current examples of PMP's include Personal Desktop Assistants (“PDA's”) and specialized devices. Examples of such specialized devices include the Rio, manufactured by Diamond Multimedia Systems, Inc. of San Jose, Calif. and the Nomad II, manufactured by Creative Labs, Inc. of Milpitas, Calif. Examples of PDA's include the Cassiopeia E-105, manufactured by Casio Computer Co., Ltd. of Tokyo, Japan; the Clio, manufactured by Vadem, Inc. of San Jose, Calif.; and the Palm VII Connected Organizer, manufactured by 3Com, Inc. of Santa Clara, Calif.

A user may download MP3, WMA, or other multimedia content to their computer or PMP and experience (i.e. listen to, watch, or receive other sensory stimuli) content, even when not connected to the Internet. When communicating with a PC (typically through a “docking station”), a PMP may allow a customer to transmit downloaded multimedia files from a computer to a PMP. A PMP can be removed from a docking station and carried around, thus providing a customer with a convenient, portable method of experiencing multimedia content.

Although there is strong consumer interest in PMP's, there is little economic incentive for multimedia producers, such as record companies, to release digital versions of their products, especially high quality, digital versions, intended to be experienced via the Internet. While producers may sell MP3, WMA, or other multimedia content from an E-commerce web site, the Internet provides a convenient method of distributing unlicensed files, thus increasing the likelihood of piracy once content is downloaded.

### SUMMARY OF THE INVENTION

The present invention improves upon the prior art by providing an economic incentive to multimedia producers to provide high quality, digital content. The present invention further improves upon the prior art by allowing personalized content delivery and other advanced features currently not provided by the prior art.

A preferred embodiment of the present invention can emulate a broadcast station, such as a radio or television station; however, the present invention can transmit its content via alternative communications methods, including, but not limited to, the Internet. Content may be transmitted as a continuous data stream (“streaming”), as a series of discrete files (“downloading”), or through a combination of either or both methods. Content may originate from centralized server(s) or from distributed collections of cooperating servers.

Content sent through the present invention can be encrypted or have other security information, such as, but not limited to, digital watermarks and/or digital rights management (“DRM”) information, embedded in it. Embedded security information may limit experiencing content to a particular PMP or group of PMP'S, may indicate that a particular selection should “expire” after a specific date or a specific number of experiences (e.g. playbacks), and may include other similar information. By creating restricted content, content providers can create a revenue source. This revenue source can provide an economic stimulus to create and provide content to users.

The present invention may also afford economic incentives to content providers by supplying a means of target marketing to users based upon user content preferences. A user of the present invention may initially indicate content preferences, and the present invention may select content based on user preferences. As an example, without intending to limit the present invention, users may select from a list of particular artists, including musicians, actors, directors, and producers, or content genres, such as country music or horror films. As a user experiences content, a review system may be available which allows a user to provide comments about specific content or a content group. If a user does not review content as it is experienced, a user may provide a response later.

Reviews may be stored on a PMP, PC, or other wireless or wired device (collectively referred to as “device”), or reviews may be immediately transmitted to a database. Review information may be used to refine content types delivered to users, thereby increasing user satisfaction.

In addition to reviewing particular content, the present invention may also provide a user with a method through which content may either be directly purchased or through which a user may indicate an interest in purchasing content. Purchasing decisions may be made prior to experiencing content, or purchasing decisions made be made while experiencing content, or purchasing decisions may be made by reexamining previously experienced content. Purchase selections may be stored on a device for later transmission to a logically centralized database, or may be transmitted automatically. Stored purchase selections may be reexamined by a user before purchase authorization.

Advertisements may also be delivered to a user based on user preferences. If a user allows advertisements, advertisements may be selected by the present invention based upon user content preferences, age, geographic location, or other demographic information. A user can indicate a desire to purchase an advertised item, and a list of desired purchases may be maintained on a device for later transmission. Purchase information may also be immediately delivered to the present invention if transmission is possible.

### BRIEF DESCRIPTION OF THE DRAWINGS

FIG. 1 is a Block diagram illustrating a general method by which a user may register and use the present invention;

FIG. 2 is a flowchart illustrating an interaction of Blocks 103 through 113 of FIG. 1 in a preferred embodiment;

FIG. 3 is a flowchart illustrating the process illustrated as Block 117 in FIG. 1, as implemented in a preferred embodiment;

FIG. 4 is a flowchart providing an overview illustration of the interaction of Blocks 117 through 148 of FIG. 1 in a preferred embodiment;

FIG. 5 is a flowchart illustrating the interaction of Blocks 121, 147, and 148 of FIG. 1 as implemented in a preferred embodiment;

FIG. 6 is a flowchart illustrating the interaction of Block 121 and Blocks 144 through 146 of FIG. 1 as presently implemented;

FIG. 7 is a flowchart illustrating the interaction of Block 121 and Blocks 141 through 143 of FIG. 1 as implemented in a preferred embodiment;

FIG. 8 is a flowchart illustrating the general interaction between Block 121 and Blocks 135 through 140 of FIG. 1 as implemented in a preferred embodiment;

FIG. 9 is a flowchart illustrating the interaction of Block 135, Block 139, and Block 140 of FIG. 1, as implemented in a preferred embodiment;

FIG. 10 is a flowchart illustrating methods by which new and registered users may interact with E-mail generated by Block 139 of FIG. 1;

FIG. 11 is a flowchart illustrating the interaction of Block 121 and Blocks 130 through 134 of FIG. 1, as implemented in a preferred embodiment;

FIG. 12 is a flowchart illustrating the workings of Block 127 and Block 128 of FIG. 1 as implemented in a preferred invention;

FIG. 13 is a flowchart illustrating the interaction of Blocks 104 through 107 of FIG. 1, as implemented in a preferred embodiment;

FIG. 14 is a flowchart illustrating the interaction of Blocks 144 through 146 of FIG. 1, as implemented in a preferred embodiment;

FIG. 15 is a flowchart illustrating the interaction of Blocks 144 through 146 of FIG. 1, as implemented in a preferred embodiment;

FIG. 16 is a flowchart illustrating a typical synchronization interaction between a PC and a PMP, illustrated as Block 1410 of FIG. 14, as implemented in the present invention;

FIG. 17 is a flowchart illustrating a set of decisions made by the present invention when a user experiences content;

FIG. 18 is a state diagram illustrating processes that may be used during synchronization;

FIG. 19 is a state diagram illustrating an interaction of various components illustrated in FIG. 20;

FIG. 20 is a Block diagram illustrating various server components of the present invention;

FIG. 21 is a Block diagram illustrating an interaction between a client and a server;

FIG. 22 is a Block diagram providing an alternative illustration of an interaction between a client and a server; and

FIG. 23 is a block diagram illustrating the multi-level Expert System employed by the present invention.

### DETAILED DESCRIPTION OF THE INVENTION

The present invention can compose and deliver multimedia content (“content”) to users via the Internet or other communications methods. The present invention may use a modified client/server approach to content delivery. A “client” may consist of software, hardware, or combinations thereof, designed into or running on a device, that allows a device to request data from a logically centralized content delivery point (“server”). A server may be physically distributed or composed of multiple individual devices which collectively perform the server function.

In addition to requesting data from a server, a client may provide access to content stored on a device, and may function as a server by providing content to other clients. Clients may communicate with other clients or with a server by removable media, or through wired or wireless means, including, but not limited to, Compact Flash memory cards, Sony Memory Sticks, Iomega Click disks, Universal Serial Bus (“USB”) cable connections, parallel cable data transmission, RS232 (“serial”) cables, ethernet, token-ring, infrared, wireless ethernet, pager, analog or digital cellular telephone, and/or satellite or other radio communications.

A software portion of a client may consist of commercially available software, customized commercial software, custom software, or combinations thereof. In a preferred embodiment, software portions of a client consist of a combination of custom software and a World Wide Web browser (“web browser”). Examples of typical web browsers include Internet Explorer, manufactured by Microsoft of Seattle, Wash., or Netscape Navigator, manufactured by Netscape of Mountain View, Calif.

A preferred embodiment delivers content to clients through a World Wide Web server (“web server”). Examples of typical web servers include Microsoft Internet Information Server, Netscape Enterprise Server, or Apache Server, manufactured by The Apache Software Foundation of Lincoln, Nebr.

Markup languages allow content delivery between servers and clients. Examples of current markup languages include, but are not limited to, Hypertext Markup Language (HTML), Standardized Generalized Markup Language (SGML), eXtensible Markup Language (XML), and Portable Document Format (PDF).

Content can include data which, when sent through appropriate hardware, software, or both, causes a stimulation of any or all senses. By way of illustration, without limiting the present invention, such sensory stimulation may include still images, video, and audio.

Content may be delivered through a variety of methods, including, but not limited to, a continuous data stream, multiple data streams, discrete file transmissions, or a combination of these methods. Content may be requested by a client prior to content delivery (“pull”), sent unrequested by a server to a client (“push”), or push and pull technologies may be combined to provide a seamless user experience. Content may be obtained by a client from a server or another client acting as a server.

In addition to full-length content, the present invention may provide content samples. Content samples may allow users to experience full versions of content, or content available for sampling may be restricted. Examples of content restrictions include, but are not limited to, shortened duration and reduced quality. Content samples may be available to all users, or content samples may be available only to users for whom an account has been created.

By creating an account, a user may be provided with a more enjoyable, interactive experience. An account may be created by a user, or the present invention may automatically create an account using information stored on or accessible to a device, such as a system serial number.

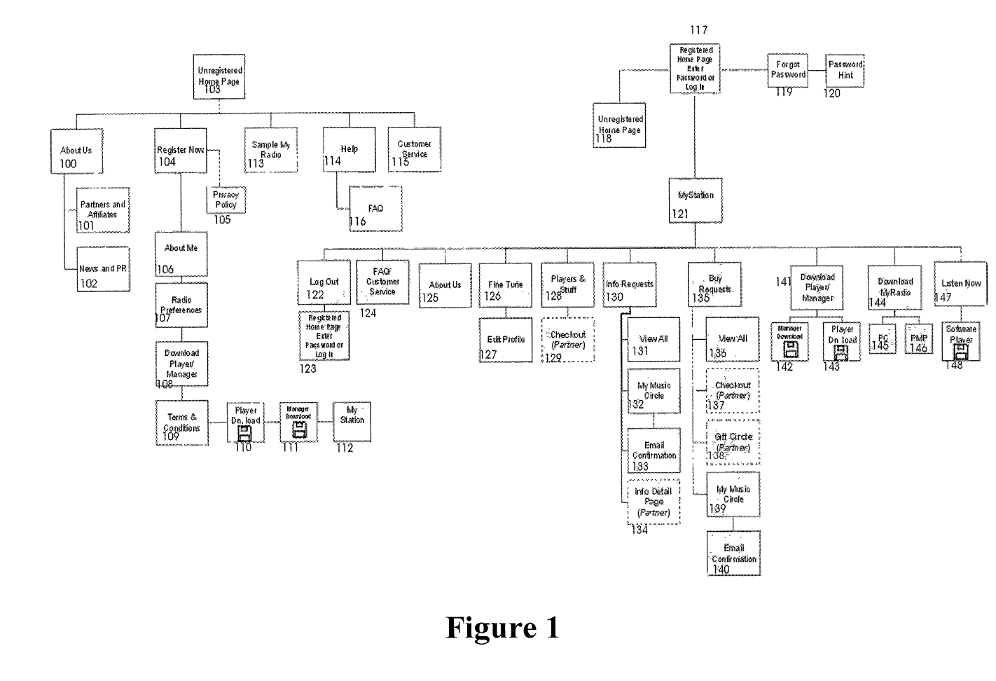

FIG. 1 is a Block diagram illustrating functions available to registered users, as well as a process through which an account may be created. Blocks 100 through 115 represent individual web pages or collections of web pages that achieve specific tasks associated with registering a user. A web page can include information provided by a web server that may be viewed with a web browser or other software or hardware capable of converting information encoded in a markup language.

An unregistered user may interact with the present invention through Unregistered Home Page 103. Among the functions accessible through Unregistered Home Page 103 are: user registration; content sampling; and the display of corporate, customer service, and technical support information.

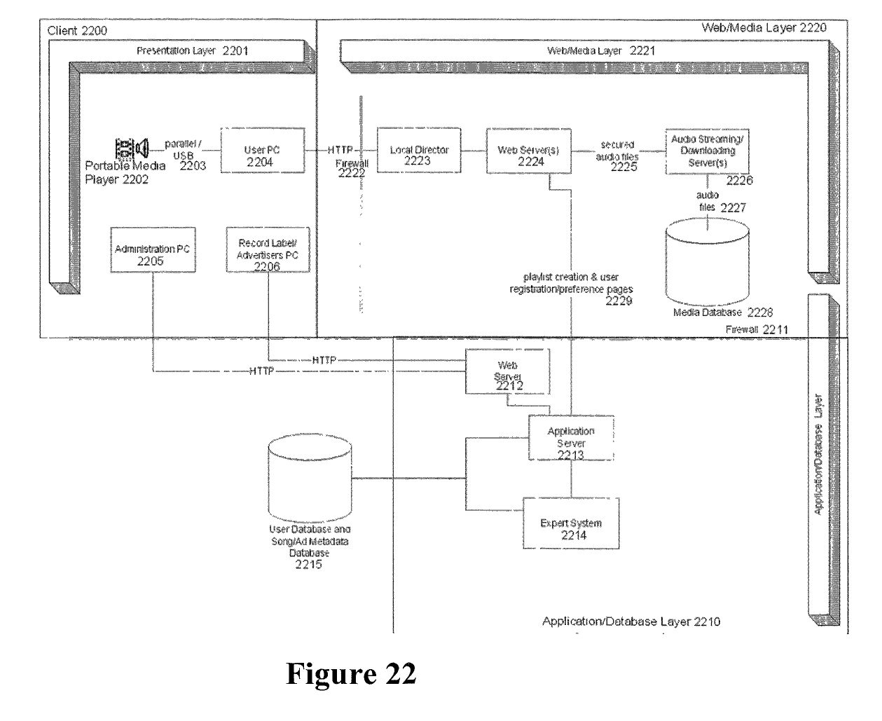

A client may communicate directly or indirectly with the present invention through a web server. An example of indirect communications is illustrated in FIG. 22, in which User PC 2204, acting as a client, is communicating with Web Server(s) 2224 through Firewall 2222 and Local Director 2223.

User PC 2204 may also act as a server, providing content to Portable Media Player 2202. The connection of Portable Media Player 2202 to User PC 2204 through parallel/USB 2203 is provided as an illustration of a preferred embodiment communications channel between a client acting as a server and another client (“downstream client”). A client acting as a server and any downstream clients can exchange content through a variety of means, including both wireless and wired communications. Examples of such connections include data transmissions via infrared, USB, serial, and Parallel connections, as well as removable media, such as Sony Memory Sticks, Iomega Click Disks, Compact Flash Memory Cards, and the like. Downstream clients, such as Portable Media Player 2202, may also connect directly to Firewall 2222 and Local Director 2223 without the use of User PC 2204. The connection between Portable Media Player 2202 and Firewall 2222 may also be accomplished through wireless or wired means.

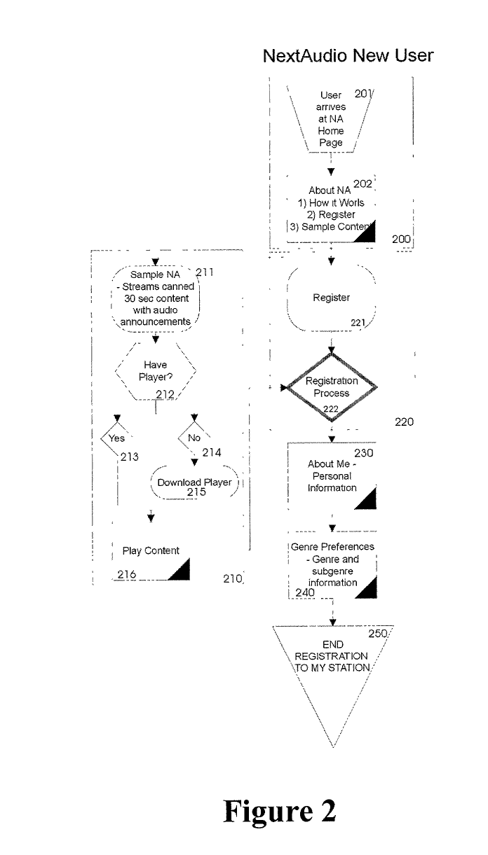

FIG. 2 is a flowchart illustrating an interaction of Blocks 103 through 113 of FIG. 1 in a preferred embodiment. Block 200 of FIG. 2 can be seen as representing Unregistered Home Page 103 of FIG. 1. Block 210 of FIG. 2 can be seen as representing Sample My Radio 113 of FIG. 1. Block 220 of FIG. 2 can be seen as representing Register Now 104 of FIG. 1. About Me 230 of FIG. 2 can be seen as representing About Me 106 of FIG. 1. Genre Preferences 240 of FIG. 2 can be seen as representing Radio Preferences 107 of FIG. 1.

A user interacting with the present invention may do so through User Arrives at N.A. Home Page (“User Arrives”) 201 in FIG. 2. A user wishing to sample content before registering with the system may indicate this desire through About N.A. 202. About N.A. 202 may also allow a user to perform several different functions, including, but not limited to, registering, gathering additional information about the present invention, and accessing other information.

A user wishing to sample content before registration may be taken from About N.A. 202 in FIG. 2 to Sample N.A. 211. Sample N.A. 211 may list various content types from which a user may choose a representative sample. If a user selects a content type for which appropriate “player” software (illustrated as Have Player 212) is not installed, appropriate software can be downloaded through Download Player 215. With an appropriate player installed on a device, a user may experience content accessible through Play Content 216.

A user may register with the present invention at any time. User registration begins with Block 220, which may present some general information to a user, such as a licensing agreement. A user may next progress to About Me 230, in which personal information, such as name, age, and home address, may be collected. About Me 230 may also ask a user to select a username and password. Usernames and passwords may be used by the present invention for several purposes, including, but not limited to, distinguishing one user from another, and securing account information.

After entering personal information, a user may then select content preferences, including selecting preferred content types from a list of those available. Content types may be presented as nested lists, with each content category containing zero or more sub-categories. In addition, each sub-category may be divided into additional sub-categories. A sample of nested content levels is:

Rock—Pop

Rock—Adult Contemporary

R&B—Jazz

R&B—Soul

Selection of content is illustrated in FIG. 2 as Genre Preferences 240.

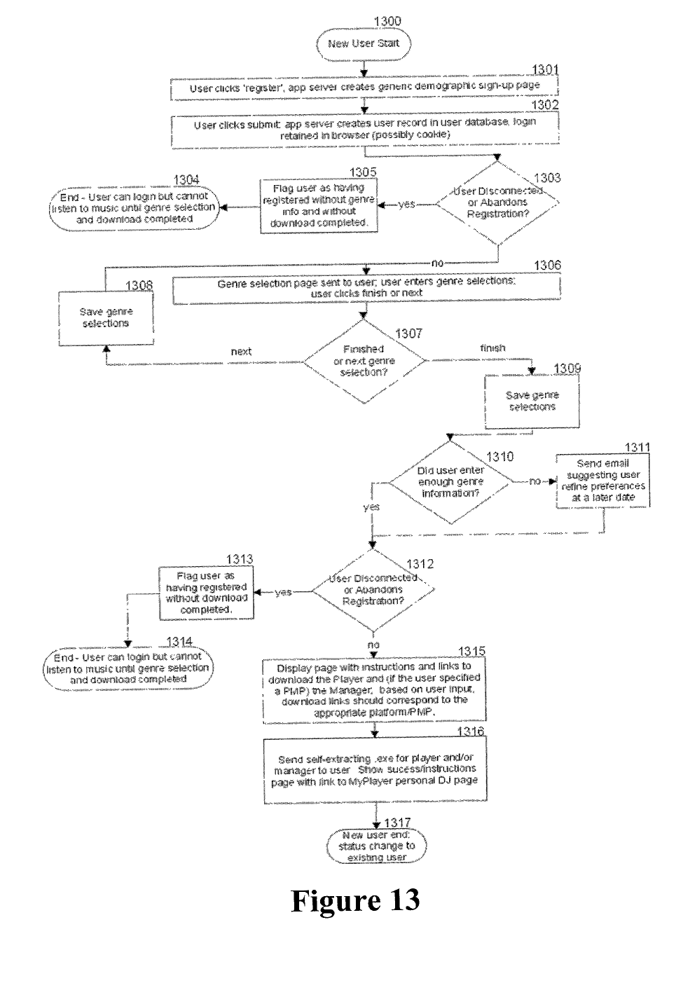

FIG. 13 is a Block diagram detailing the registration and customization processes illustrated as Blocks 220, 230, 240, and 250 in FIG. 2. New User Start 1300 represents a registration process starting point. New User Start 1300 may contain a button or other link labeled “register”, “create account”, “sign up”, or other similar terminology. A user activating such a button may be presented with Block 1301, in which personal information may be entered. Personal information may include a name, address, E-mail address, type(s) of PMP(s) owned, a username and password by which a user may be identified and access to the account can be limited, password hints, and the like.

Block 1301 may have a button or other link that is labeled “submit”, “done” “continue”, or other similar label. A user activating such a button may cause personal information to be stored on a client, on a server, or both, as illustrated in Block 1302.

An account belonging to a user who disconnects from Block 1303 or abandons personal information entry after submitting generic information from Block 1302 may be marked as incomplete (Block 1305). A user attempting to access the present invention through an incomplete account may be required to select content genre preferences (Block 1304) prior to experiencing content. Content genre preferences may be indicated through Block 1306.

As content genre preferences are entered, a user may activate a button or other link entitled “next”, “forward”, “more”, or similar label to display additional content genres. As illustrated by Block 1307, if a user selects “next”, their content genre preferences can be saved by the present invention (Block 1308), and additional content preference options may be presented (Block 1306).

When a user has completed the entry of content genre preferences, a user may activate a button or other link labeled “save”, “finish”, “done”, or other similar label. As indicated by Block 1307, when a user selects “finish”, their content genre preferences may be stored (Block 1309), and content genre preferences may be reviewed by a user and/or the present invention. In Block 1310, if a user has not entered enough content genre information to provide a custom listening experience, an E-mail may be sent recommending that content genre preferences be refined at a later date.

A user account belonging to a user who disconnects or abandons registration after indicating content genre preferences may be marked as partially complete (Block 1313). A user accessing the present invention through a partially complete user account may be required to indicate additional content genre preferences prior to experiencing content (Block 1314).

After sufficient content genre preferences have been entered, instructions for downloading software and/or content may be displayed (Block 1315). If software is selected for download, it may be delivered through a web page or other means, as illustrated by Block 1316. After any necessary software has been downloaded, a user account may be marked as completely configured, as indicated by Block 1317.

After a user account is configured, My Station 121 of FIG. 1 may be displayed. My Station 121 of FIG. 1 is also illustrated as My Station 250 of FIG. 2 and My Station 112 in FIG. 1.

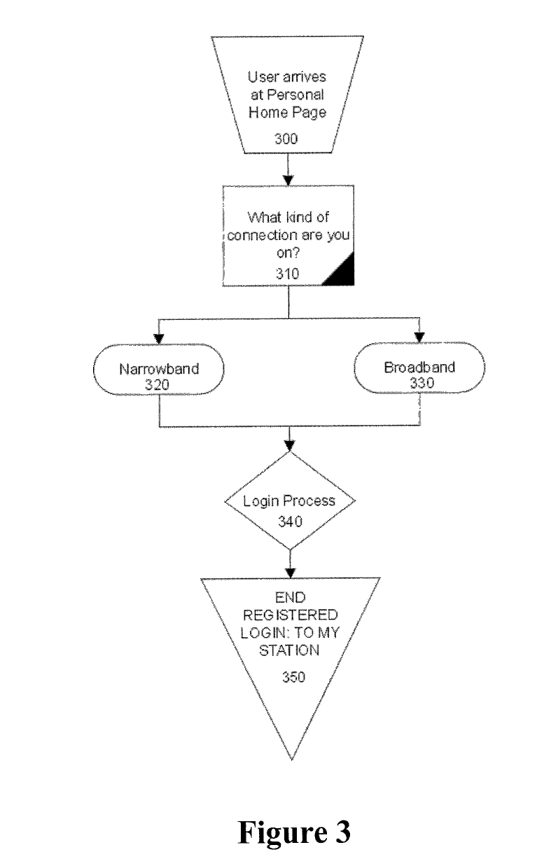

My Station 121 may also be accessible to users who have previously registered with the present invention. Users already registered with the present invention may access My Station 121 by first visiting Registered Home Page 117. Functions implemented through Registered Home Page 117 are also illustrated in FIG. 3.

Registered Home Page 117, which is illustrated as User Arrives at Personal Home Page (“User Arrives”) 300 in FIG. 3, may be presented when a user who has already created an account attempts to interact with the present invention. User Arrives 300 can determine, through software, hardware, or by asking a user, a data transmission rate appropriate for a given user session, as illustrated by Block 310. Data transmission rate information may be stored for later use, as illustrated by Narrowband 320 and Broadband 330.

A user may also enter a username and password combination, or a username and password may be determined from a device. This process is illustrated as Logon Process 340 in FIG. 3.

If a user enters an incorrect username/password combination, access to My Station 121 of FIG. 1 may be denied, and a user may be taken to Unregistered Home Page 118 (which is also illustrated as Unregistered Home Page 103). If a user forgets a previously chosen username and password combination, Forgot Password 119 may be displayed. Forgot Password 119 may allow a user to see a password “hint”, or reminder. Password hints may be displayed on the same web page as Forgot Password 119, or may be displayed on a separate web page, as is illustrated in FIG. 1.

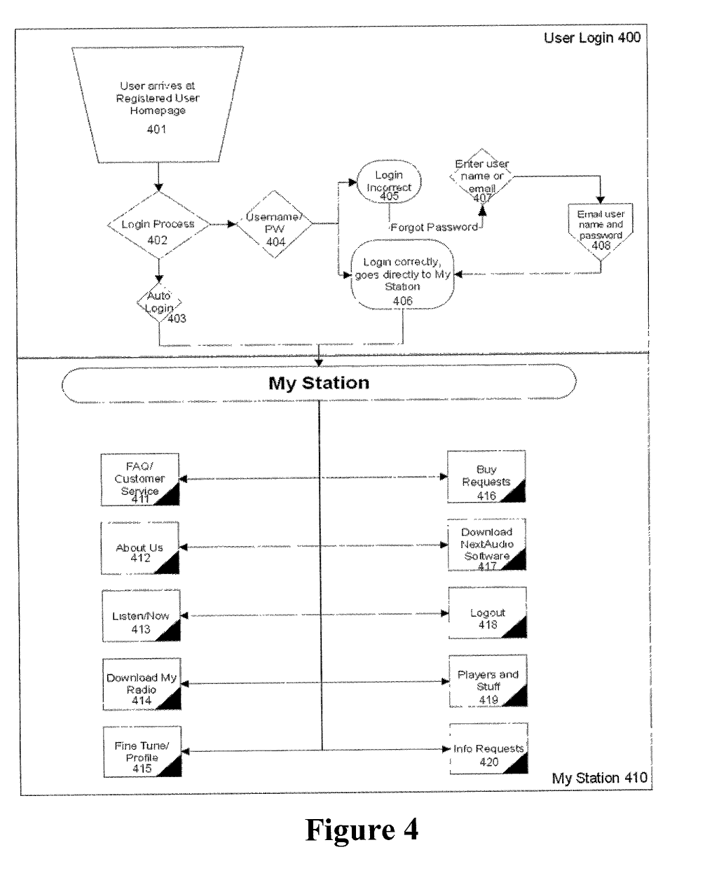

Login processing is also illustrated by User Login 400 of FIG. 4. A user interacting with the present invention may enter a username and password in User arrives at Registered User Homepage 401. If a username and password can be determined automatically (Auto Login 403), My Station 410 may be immediately accessible. If a username and password cannot be automatically determined, a user may be asked to enter a username and password (Username/PW 404). If a correct username is entered, My Station 410 may be accessible through Login Correctly 406.

User Login 400 illustrates an additional option not shown in FIG. 1. If a user has forgotten his or her username and/or password, User Login 400 may allow a user to request this information. A user who has forgotten his or her password or entered an incorrect password (Login Incorrect 405) may enter an E-mail address associated with a user account or a username into Enter user name or Email 407. Enter user name or Email 407 may automatically transmit an appropriate username and password to an appropriate E-mail address (Email user name and password 408).

After a data transmission rate has been selected (FIG. 3) and a user has logged on (FIG. 4), the present invention may allow a user to interact with My Station 121 of FIG. 1. My Station 121 of FIG. 1 may serve as a portal through which features of the present invention may be accessed. Examples of features which may be accessible through My Station 121 include, but are not limited to, software downloads; content genre preference editing; content purchases; E-mail, chat, and/or video conferencing; hardware purchases (such as PMP devices); and access to user support information. These options are illustrated in both FIG. 1 and as part of My Station 410 of FIG. 4.

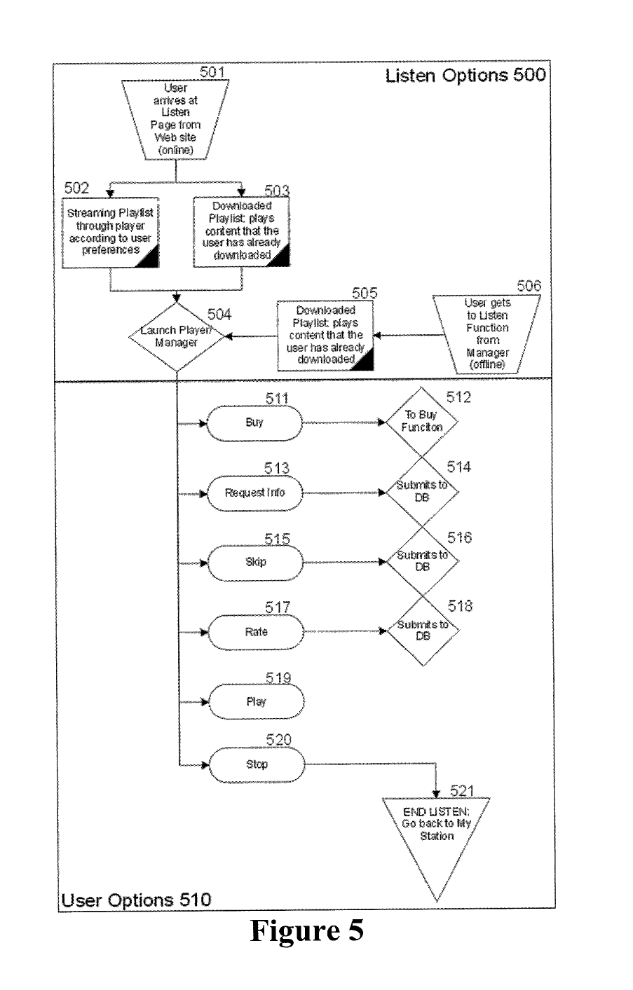

A user wishing to experience content may visit Listen Now 147 of FIG. 1. A flowchart exemplifying user interaction with and functions available through Listen Now 147 is illustrated in FIG. 5. A user may request a continuous content stream, illustrated as Streaming Playlist 502, download and experience content, or a user may experience content already stored on a device, as illustrated by Download Playlist 503. Selection of either option can activate software appropriate to selected content, as illustrated in Launch Player/Manager 504.

In addition to traditional controls such as start (Play 519), stop (Stop 520), skip (Skip 515), intensity (such as volume), and pause, a user may control content and interact with the present invention in new ways. Examples of new forms of interaction include, but are not limited to, allowing a user to indicate a desire to purchase content (Buy 511), request additional content information about (Request Info 513), or review content (Rate 517).

Information requests, content reviews, and other user interaction may be recorded by the present invention and transmitted to a server later. A server may use such information to generate detailed ratings and information request reports to content providers, tune internal server mechanisms, comply with licensing agreements and applicable laws, and for other purposes.

If a server is readily contacted by a device, results may be transmitted immediately (Blocks 514, 516, and 518). If a user indicates a desire to purchase content, this information may be stored on a device, or transmitted to a server acting as part of the present invention (Block 512).

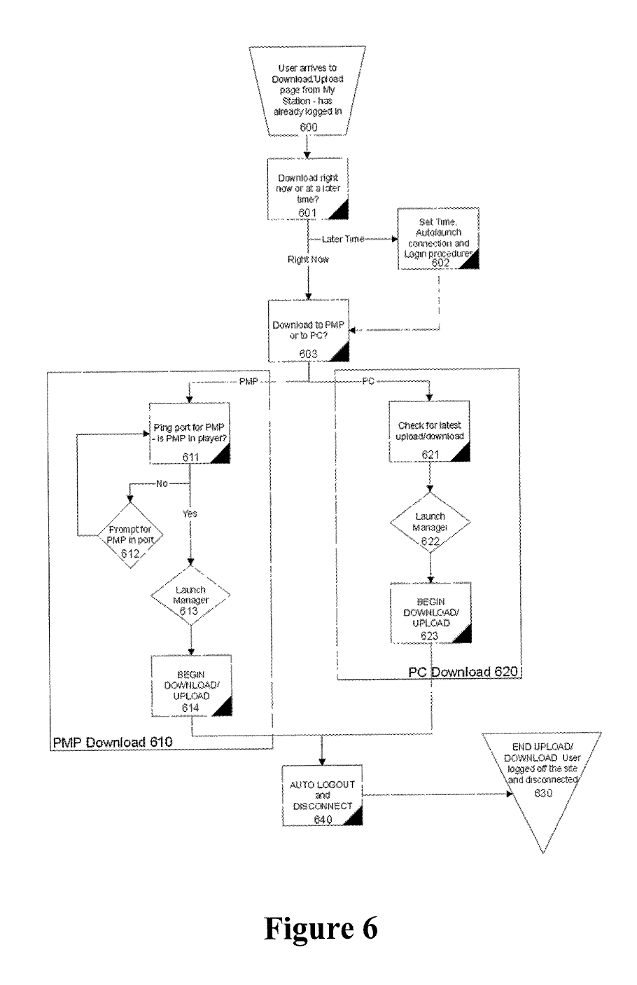

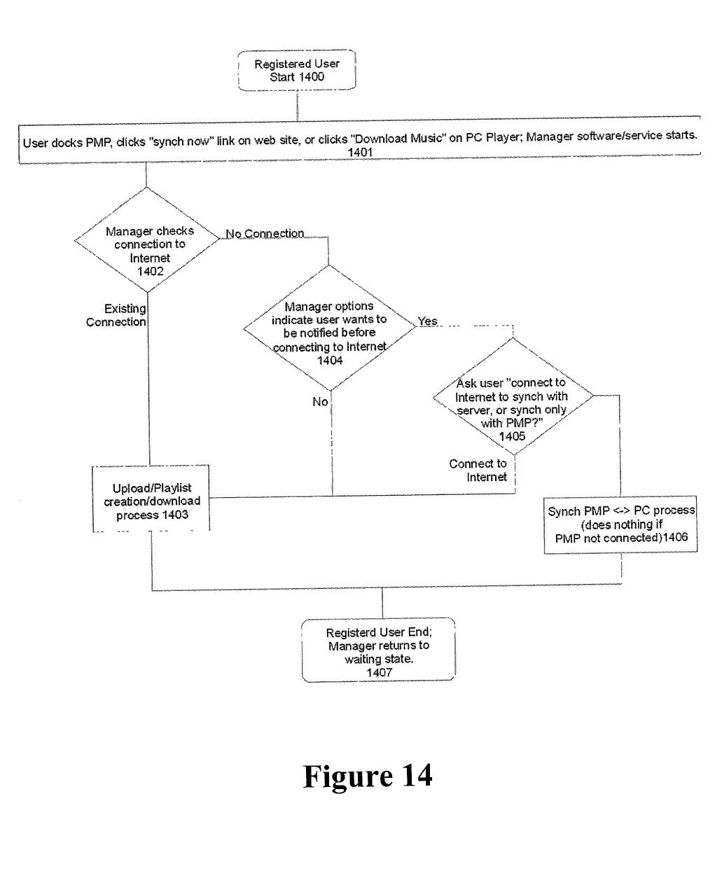

A user interacting with the present invention through My Station 121 of FIG. 1 may also store content on a device for later review. This interaction is handled through Download MyRadio 144, PC 145, and PMP 146. Examples of download options and logic performed by the present invention, a user, or both, are illustrated by FIG. 6. In addition to FIG. 6, FIG. 14 provides an overview of logic used by the present invention when downloading data to a display device.

In FIG. 6, a user can begin downloading through Block 600. At Block 601, a user may select whether to download content now or at some point in the future. If a user selects a download time in the future, software may be run that monitors the time, the present invention may enable itself at a specified time, or the present invention may continue to run until a specified time (Block 602). At a specified time, content downloads may begin without user interaction (Block 603). If a download is to take place in the future, a user may also be asked whether content should be downloaded to a PC or to a PMP, or this may be automatically configured as part of user preferences.

Downloads to PMP devices may follow logic illustrated in Block 610 of FIG. 6. The present invention may send a query to a PMP to verify a PMP is ready to receive information (Block 611). If a PMP is not ready or is not communicating with the present invention, a notification may be displayed indicating this to a user and requesting review of any connections between devices (Block 612). When a PMP is detected, appropriate software may be run on a PMP or a connected device (Block 613) to begin downloading content to a PMP (Block 614).

Downloads to a device follow logic illustrated in Block 620 of FIG. 6. A client, running on a device, checks to see whether new content is available (Block 621). If new content is available, software may be launched (Block 622) and a download may begin (Block 623).

Although Blocks 630 and 640 of FIG. 6 indicate that a user is logged out of the present invention, this may not always be the case. For example, if a user is reviewing content genre preferences, purchasing content, or otherwise interacting with the present invention, a user session will not be terminated.

FIG. 14 illustrates a procedure for synchronizing content between a PMP and a device. As previously mentioned, a client can also act as a server, transmitting files to other clients. In FIG. 14, content has been downloaded to a device, and a user wishes to transmitting content to a PMP. A button or other link labeled “synch now”, “synchronize”, “create image”, “download”, “download content”, “download music”, or other similar label may be presented as part of Registered User Start 1400. By activating “synch now”, processing shifts from Registered User Start 1400 to Manager checks connection to Internet 1402, in which the present invention may attempt to communicate with a server.

If communication can be established, processing continues through Upload/Playlist creation/download process 1403. In Upload/Playlist creation/download process 1403, information stored on a device, such as purchase information, content ratings, and the like, may be transmitted to a server for processing. In addition, downloading of new content may begin.

If the client is running on a device that is not communicating with a server, an attempt may be made to communicate with a server. If, as illustrated in Block 1404, a user does not wish to be notified before a connection is made, a connection may be established and processing may flow to Upload/Playlist creation/download process 1403. If a user wishes to be notified before a connection is initiated, processing may flow from Block 1404 to Block 1405.

As illustrated in Block 1405, if communications can be established, processing may proceed to Upload/Playlist creation/download process 1403. If communications cannot be established, files may be transmitted from one client to another, if a second client is available.

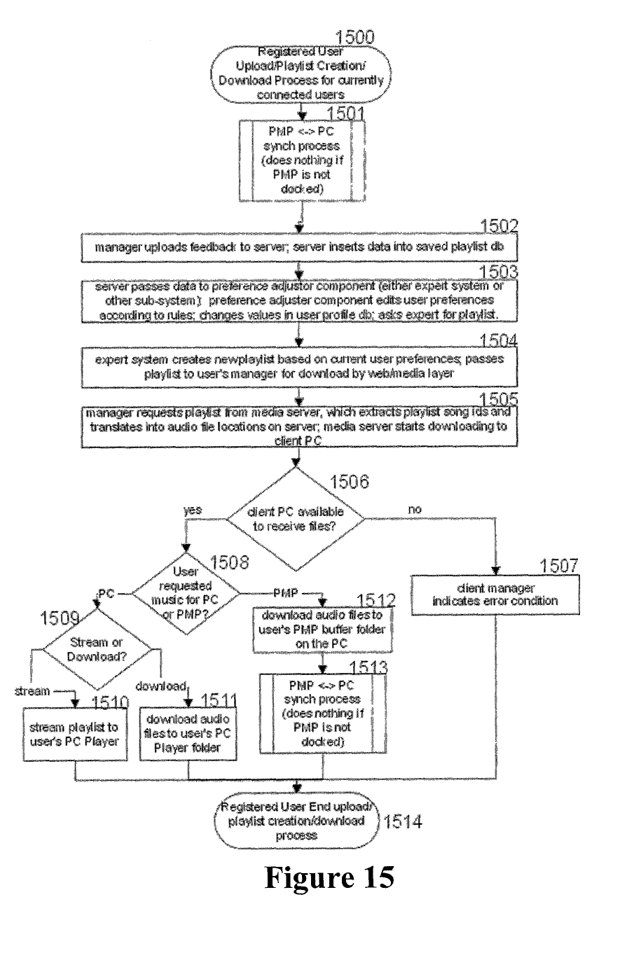

FIG. 15 illustrates logic performed as part of Upload/Playlist creation/download process 1403 of FIG. 14. Beginning with Block 1500 of FIG. 15, when communications are established, a synchronization of content on a device and any downstream or other clients may begin (Block 1501). After content synchronization has begun, any information stored on a connected client, including downstream clients, may be transmitted to a server acting as part of the present invention (Block 1502). Data that may be transmitted to a server includes content reviews, content purchase information, and other similar information.

User content genre preferences may be modified based on user content preferences transmitted from a client, as illustrated in Block 1503. After content genre preferences have been modified, a new playlist may be created based on updated preference information (Block 1504). A new playlist may determine content to be delivered to a client. A playlist may be transmitted to a client, which in turn can request content based on a playlist (Block 1505), or a playlist may be used by a server acting as part of the present invention to deliver content directly to a client.

As indicated by Blocks 1506 and 1507, if a client is no longer available, an error condition occurs. If an error occurs, a notification or error message may be displayed, and the Upload/Playlist creation/download process may terminate.

If, as indicated by Blocks 1506 and 1508, a client is available and content indicated on a playlist is available, content downloading or streaming may begin. In a preferred embodiment illustrated by FIG. 15, if a user has requested content for a PMP, that content may be downloaded to a device or to a PMP or other downstream client (Block 1512). After each content file is downloaded, files may be synchronized between a PMP and a device. When content downloads are complete, a synchronization process may also be run. Such synchronization may ensure that all downloaded content has been transmitted to a PMP or downstream client (Block 1513). If a PMP is unavailable during synchronization, synchronization may be terminated. However, content downloads may continue even in the absence of a PMP. After all content has been downloaded, processing continues to Block 1514, which may return control to My Station 121 of FIG. 1.

If content is requested for a specific device, processing may flow from Block 1508 to Block 1509. If users request content in the form of discrete files, those files may be downloaded from a server to a device, as illustrated by Block 1511. If a stream of content has been requested, delivery of that stream may be made available through Block 1510. After content downloads have finished and content streaming has stopped, processing may continue to Block 1514. Processing may also continue to Block 1514 while content is streamed, thereby allowing users access to other functions provided by the present invention. Block 1514 may return a user to My Station 121 of FIG. 1.

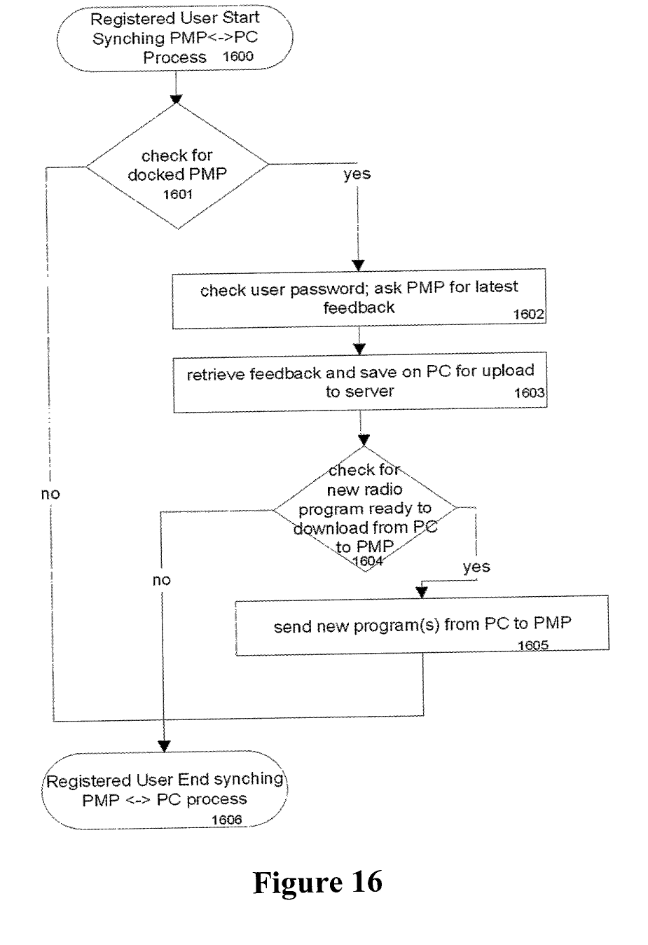

FIG. 16 provides a functional illustration of the synchronization process illustrated in FIG. 15 as PMP<—> PC Synch Process 1513 and in FIG. 14 as Synch PMP <—> PC process 1406. In FIG. 16, a synchronization process may begin with Block 1600. If a PMP or other downstream client is not communicating with a device (Block 1601), processing may proceed to Block 1606, thus ending the synchronization process.

If a PMP or other downstream client is communicating with a device (Block 1601), processing may pass to Block 1602. As indicated in Block 1602, when a PMP or other downstream client is connected, a password may be required before information retrieval. After a proper password is entered (if required), content ratings, content purchases, and other information stored on the PMP may be transmitted to a device with which a PMP can communicate. Information from a PMP may also be transmitted directly to a server operating as part of the present invention (Block 1603).

After any feedback information is retrieved from a PMP, a device may check for new content to be synchronized with the PMP (Block 1604). If there is new content, processing passes to Block 1605, in which content may be delivered to a PMP or downstream client. If there is no new content, processing passes to Block 1606, which ends synchronization.

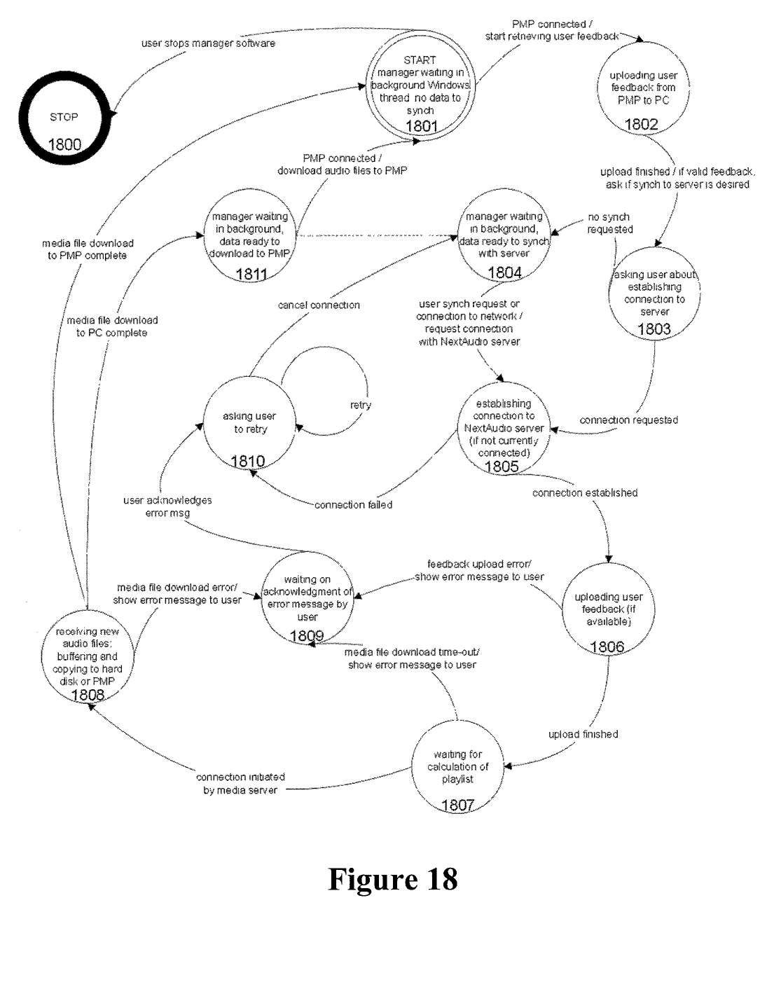

Although FIG. 16 illustrates synchronization as feedback retrieval and then synchronization, this process may also occur in the opposite order, or synchronization and feedback retrieval may occur simultaneously. FIG. 18 is a state diagram illustrating content synchronization between a client and a downstream client.

Block 1801 may begin synchronization. In Block 1801, a client may provide content to a user or perform other tasks while waiting for a downstream client to connect. When a connection is detected, processing may move to Block 1802, in which user feedback is uploaded from a downstream client to an upstream client. When user feedback has been uploaded, processing may continue to Block 1803.

In Block 1803, if automatic updates have been authorized, processing may skip from Block 1803 to Block 1806. If a user has selected not to allow automatic content updates, or if a connection with a server cannot be established, a user may be asked to establish a connection to a server. If a user decides not to establish a connection with a server, or if synchronization with a server is not desired at the present time, processing may continue with Block 1804. Block 1804 may periodically request that a user initiate a connection to a server to upload feedback information and download new content or playlists. When a connection to a server is allowed, processing may pass to Block 1805. If a connection is established, processing may proceed to Block 1806.

If a connection cannot be established with a server, processing may flow from Block 1805 to Block 1810. Block 1810 may notify a user of a failed attempt to communicate with a server, and processing may return to Block 1804.

After a connection has been successfully established with a server, processing may flow from Block 1806, in which user feedback may be uploaded to a server, to Block 1807. When new feedback is uploaded to a server, a server may adjust user content genre preferences based on new feedback. In Block 1807, a playlist may be calculated based on recently updated user content genre preferences.

If an error occurs while uploading feedback information in Block 1806 or during playlist calculation in Block 1807, processing may proceed to Block 1809. Block 1809 may notify a user of a problem, then proceed to Block 1810.

If a playlist is properly calculated and transmitted to a client, content download may begin in Block 1808. When content has been downloaded, processing may continue to Block 1811 or Block 1801. The next processing step may be determined based on whether content still must be delivered to downstream clients.

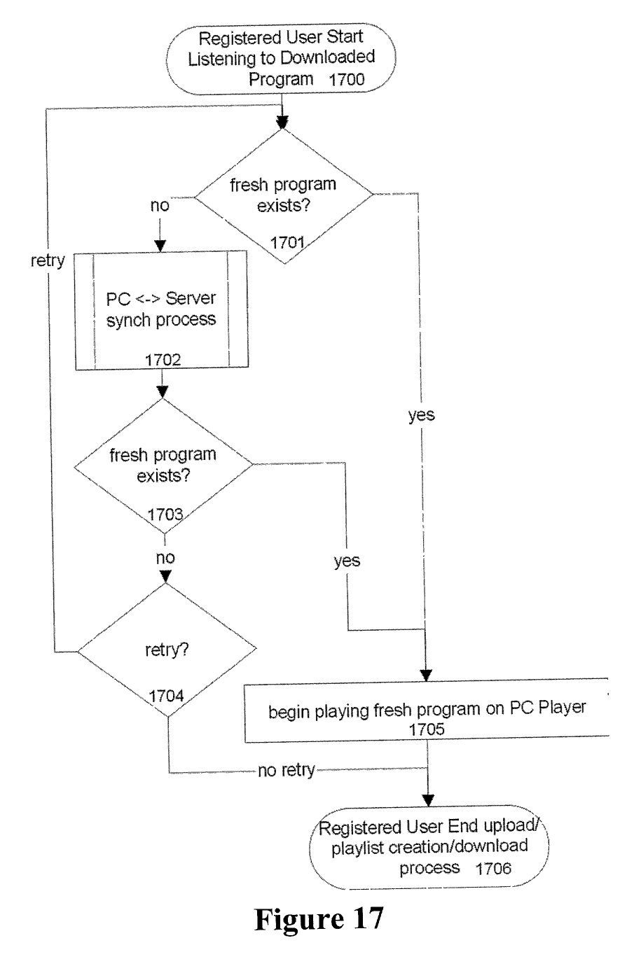

Once content has been delivered to a PMP or other downstream client, synchronization ends and a user may begin experiencing content by activating “play”, “start”, or other similarly named button or other link on a client. FIG. 17 illustrates a process through which a user may experience content.

Block 1700 of FIG. 17 may be entered when a user activates a play button on a client. If content was previously downloaded, or streaming content is available, content may be immediately experienced, as illustrated in Block 1705. If new content is not available, a new playlist may be requested from a server, as illustrated in Block 1702. If a new playlist is available, content may be downloaded or streamed to a client to allow immediate content experience, as illustrated in Block 1703. If a playlist is still unavailable, the process may repeat until a predefined number of retries have been exhausted, as illustrated in Block 1704. When all retries have been exhausted and no playlist is available, the process may exit through Block 1706 and return to My Station 121 of FIG. 1.

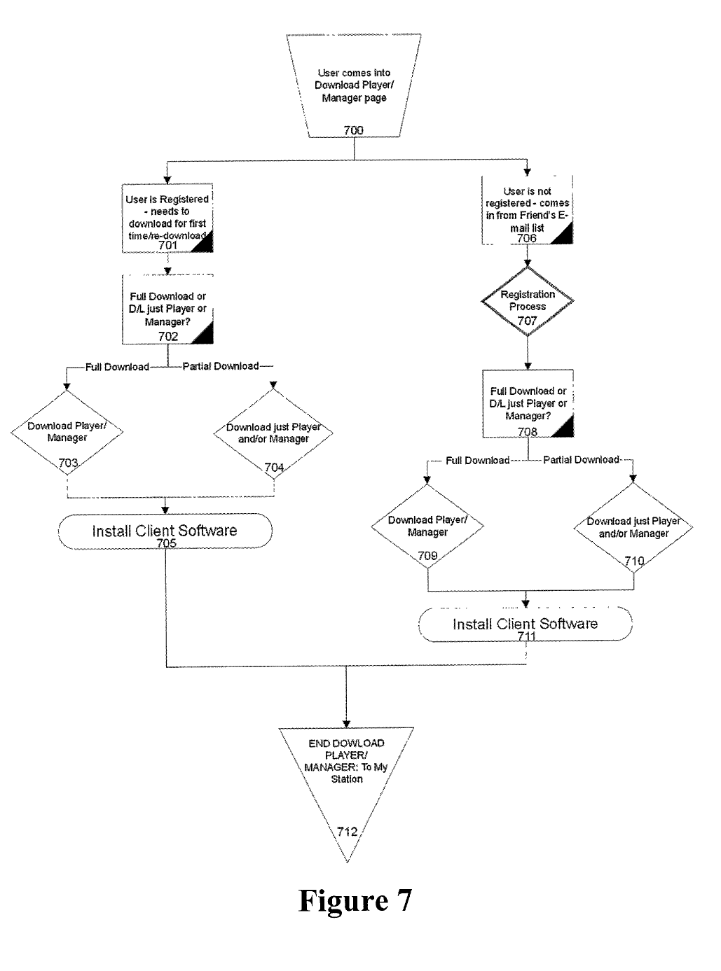

My Station 121 may allow a user to download software through Download Player/Manager 141, Manager Download 142, and Player Dn. Load 143, which are illustrated in more detail by FIG. 7. Download Player/Manager 141, illustrated as Block 700 of FIG. 7, allows access to software downloads. If a registered user is accessing Download Player/Manager 141, processing may flow from Block 700 of FIG. 7 to Block 701. In Block 701, either the present invention can determine or a user may indicate that software is being downloaded for the first time. In Block 702, a user may be asked whether all software should be downloaded (Block 703), or only individual software pieces (Block 704). Once all specified software has been downloaded, processing may flow to Block 705, in which downloaded software may be installed on a device.

An unregistered user may gain access to Block 700 through an E-mail sent by a registered user. This is illustrated as Block 706 of FIG. 7. An unregistered user may experience restricted content, or an unregistered user may register and experience unrestricted content (Block 707). If an unregistered user does not have software necessary to experience content recommended by a registered user, an unregistered user may download software through Block 708. An unregistered user may be given the opportunity to download all available software (Block 709), or specific software pieces (Block 710). Once all specified software has been downloaded, processing may flow to Block 711, in which downloaded software may be installed on a device.

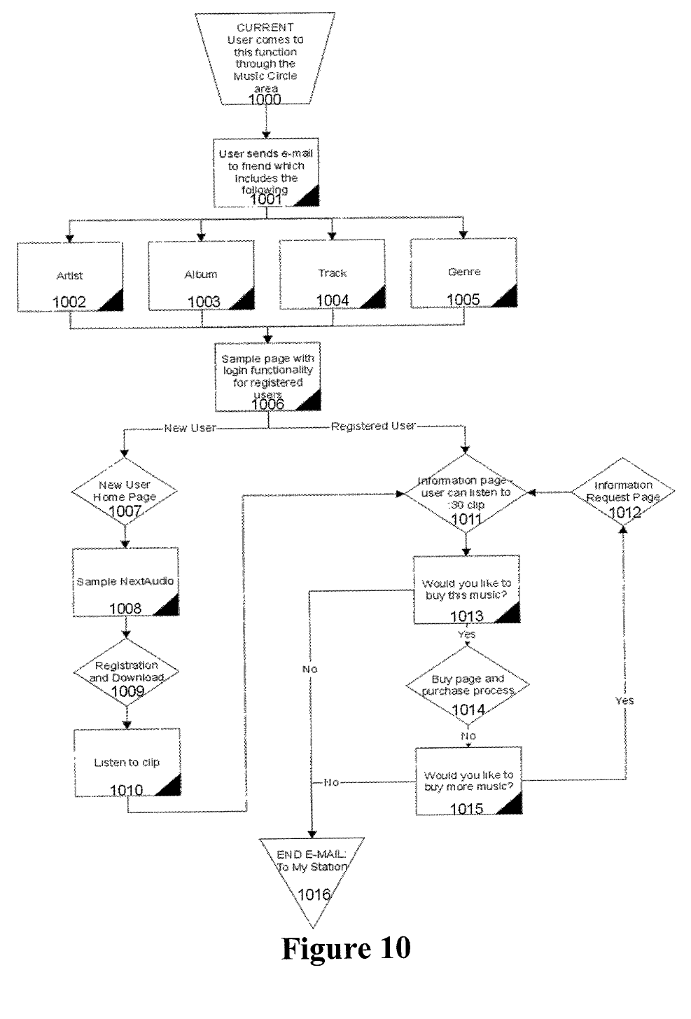

Review of content by an unregistered user is illustrated in more detail in FIG. 10. In Block 1000, a registered user may send an E-mail message to a friend indicating content in which a friend may be interested. A recipient of such an E-mail message (Block 1001) may see descriptions of content, including, but not limited to, content author (Artist 1002), collection to which content belongs (Album 1003), identification number within collection (Track 1004), and genre(s) into which the content belongs. Also included in such a message may be a link or other device that allows a recipient to experience content selected by a registered user.

Restricted content may be experienced through Block 1006. In addition, Block 1006 may allow a registered user to login to the present invention and access unrestricted content, as illustrated by Block 1011. If an unregistered user wishes to register, an unregistered user may be taken to Block 1007. Block 1007 may allow an unregistered user to sample restricted content (Block 1008), and allow registration (Block 1009). After registration, access may be granted to additional content (Block 1010).

A registered user may experience additional restricted content through block 1011. A user may indicate a desire to purchase content through Block 1013. Purchases may be handled by Block 1014. Block 1014 may provide an interface to content providers, for example record manufacturers, movie studios, or third parties selling content, or Block 1014 may allow purchases directly from the present invention. A user wishing to purchase additional content may indicate a preference through Block 1015, which may direct a user to Block 1012 and back to Block 1011.

After software has been downloaded and installed, a registered user may return to My Station 121 of FIG. 1. After software has been downloaded and installed for an unregistered user, an unregistered user may be taken to Unregistered Home Page 103 of FIG. 1.

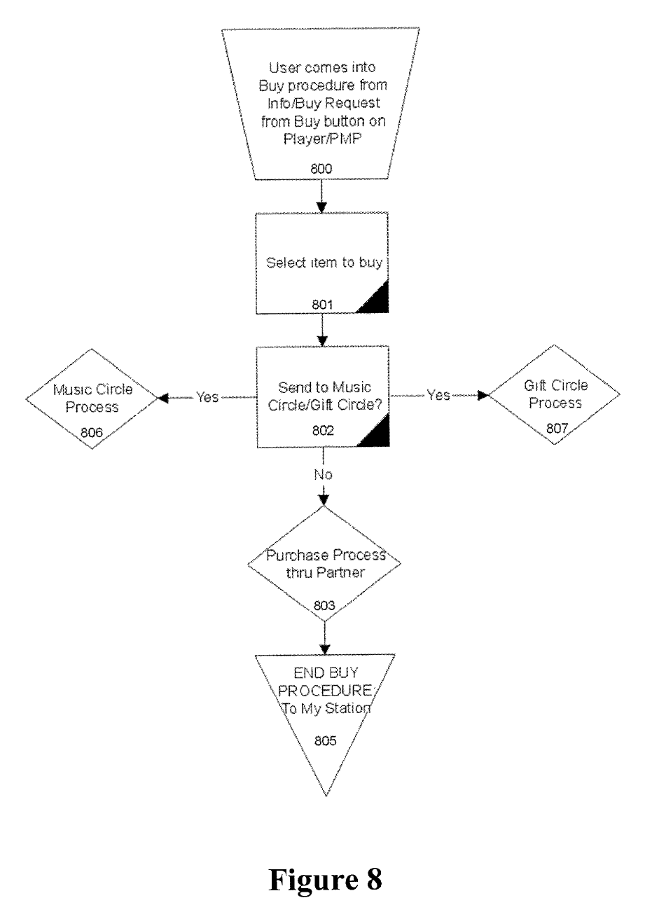

A registered user viewing My Station 121 may also access Buy Requests 135. Buy Requests 135 may provide a convenient interface to View All 136, Checkout 137, Gift Circle 138, My Music Circle 139, and Email Confirmation 140. Buy Requests 135 is also illustrated by FIG. 8. A user accessing Buy Requests 135 of FIG. 1 may be presented with Block 801 of FIG. 8 by activating a button or other link labeled “Buy”, “Purchase”, or other similar label. Activating such a button can cause Block 801 to be displayed. Block 801 can allow a user to select content to be purchased. A user may select content in which a user previously indicated an interest (e.g. through a client while content was experienced), or a user may select content from a catalog or catalogs.

When a user has selected desired content, Block 802 may be displayed. Block 802 may allow a user to utilize content selections in various manners, including, but not limited to, purchasing content (Block 803), adding selected content to a list or lists of content a user would like as a gift (Block 807), and sending information about selected content to a friend (Block 806). Block 803 corresponds to Checkout 137 of FIG. 1. Block 806 corresponds to My Music Circle 139 of FIG. 1. Block 807 corresponds to Gift Circle 138 of FIG. 1.

Gift Circle 138 may be a list maintained by the present invention or by a third party through which a user may indicate an interest in particular content or content genres. Others interested in purchasing content as a gift for a registered user may review choices indicated in Gift Circle 138 and purchase selections either directly from the present invention or through a third party or third parties.

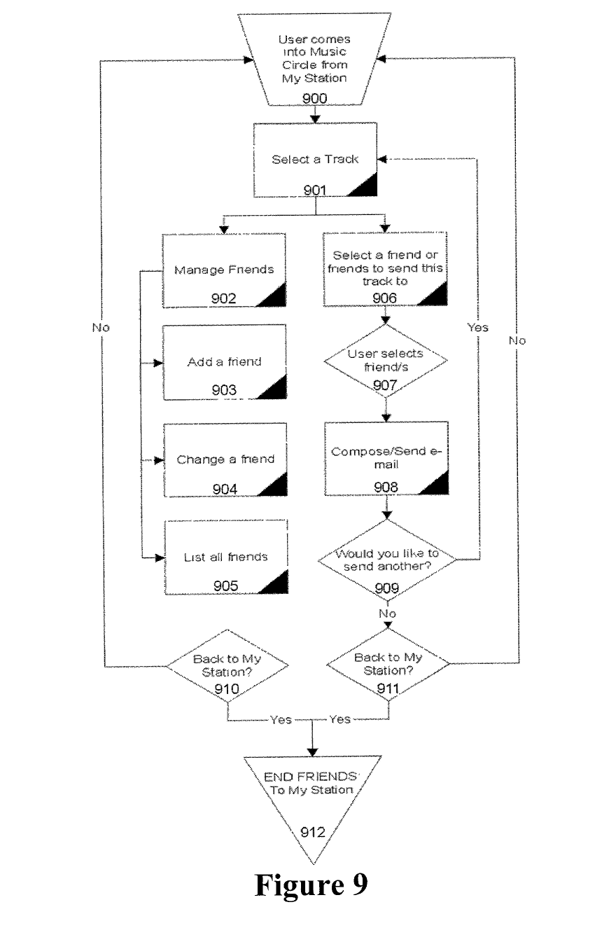

My Music Circle 139, illustrated in more detail in FIG. 9, may allow a user to notify others through E-mail about content in which a user thinks others may be interested. Block 900 of FIG. 9 illustrates a starting point from which E-mail may be generated. Block 902 may allow a user to add (Block 903), edit (Block 904), and/or delete (Block 905) a friend from a list of friends. Block 902 may also allow the creation of distribution lists to facilitate communication.

Block 901 may allow a user to select content about which E-mail will be sent. After content has been selected, Blocks 906 and 907 may allow a user to select a friend, friends, or a distribution list to which the E-mail will be sent. After content and recipients have been selected, a user may add a personalized message before transmission (Block 908). After a message is sent, a delivery confirmation may be presented to a user (illustrated as Email 140 of FIG. 1). A user may then select additional content to be included in E-mails (Block 909), modify friend lists (Block 911), or return to My Station 121 of FIG. 1 (Block 912).

My Station 121 of FIG. 1 may also allow a user to purchase software, as well as PMP's, other electronics, and other products either directly from the present invention, or through a third party. This is illustrated in FIG. 1 as Players & Stuff 128 and Checkout 129.

A user experiencing content may request information about that content through a button or other link. Information requests may be stored on a device if a server is unavailable, or information requests, including previously stored requests, may be transmitted to a server when a server is available. My Station 121 may allow a user to view additional information about specific content through Info Requests 130.

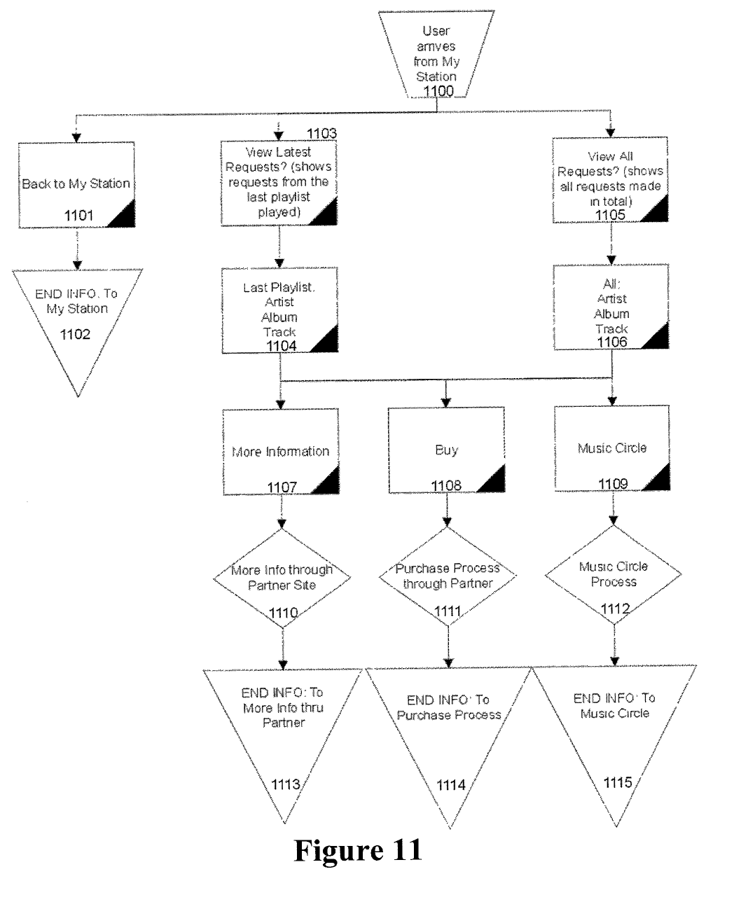

Info Requests 130 is illustrated in more detail by FIG. 11. As illustrated in FIG. 11, a user may view all requests (Block 1105), or a user may filter requests based on specific criteria (Block 1103). A list of all requests matching given criteria may then be presented (Block 1104), or, if no criteria are given, a list of all requests may be displayed (Block 1106).

A user may remove any previous requests from a list, and then view information about any or all content still remaining in a list. This is illustrated in FIG. 11 by the flow between Block 1107, Block 1110, and Block 1113.

A user may also use information request lists in Music Circles, as illustrated by Block 1109, Block 1112, and Block 1115. Information request lists may also be used to generate a list of content to be purchased, as illustrated by Block 1108, Block 1111, and Block 1114. When a user has finished reviewing content information, a user may be returned to My Station 121 of FIG. 1.

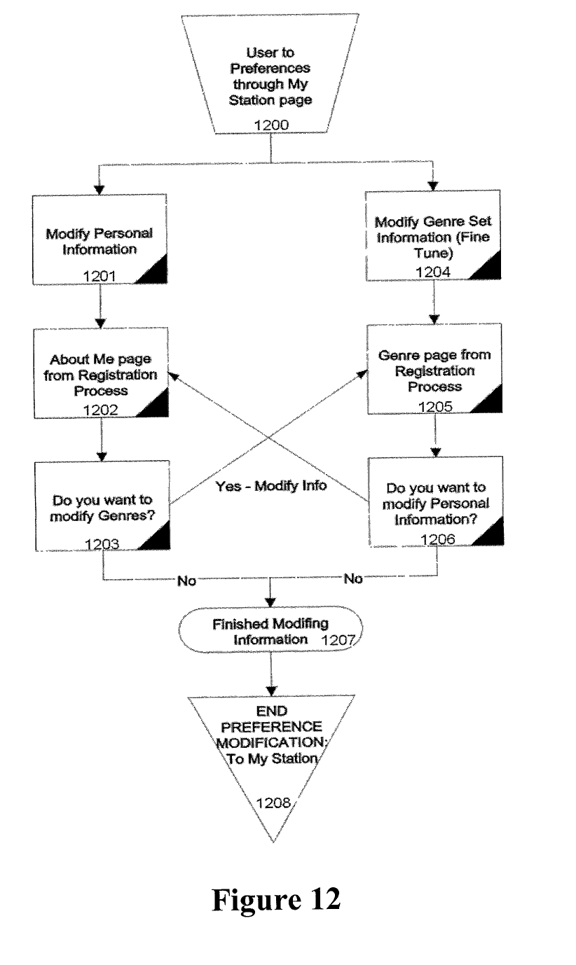

My Station 121 may also allow a user to modify content genre preferences and personal information stored as part of a user account, as illustrated by Fine Tune 126 and Edit Profile 127. This process is illustrated in more detail in FIG. 12. A user may modify personal information (Block 1201) through an interface similar to About Me 106 of FIG. 1 (Block 1202). When a user has finished modifying personal information, a user may edit content genre preferences (Block 1203).

Content genre preferences may be modified through Block 1205. Content genre preferences may be presented in a format similar to Radio Preferences 107 of FIG. 1. When a user has finished modifying content genre preferences, a user may modify personal information (Block 1206).

When a user has finished editing content genre preferences and personal information (Block 1207), a user may be returned to My Station 121 of FIG. 1.

My Station 121 may also provide additional features, such as, but not limited to, access to frequently asked questions and customer service (FAQ/Customer Service 124), and information about the present invention (About Us 125). A user who has finished interacting with the present invention may indicate this by accessing Log Out 122.

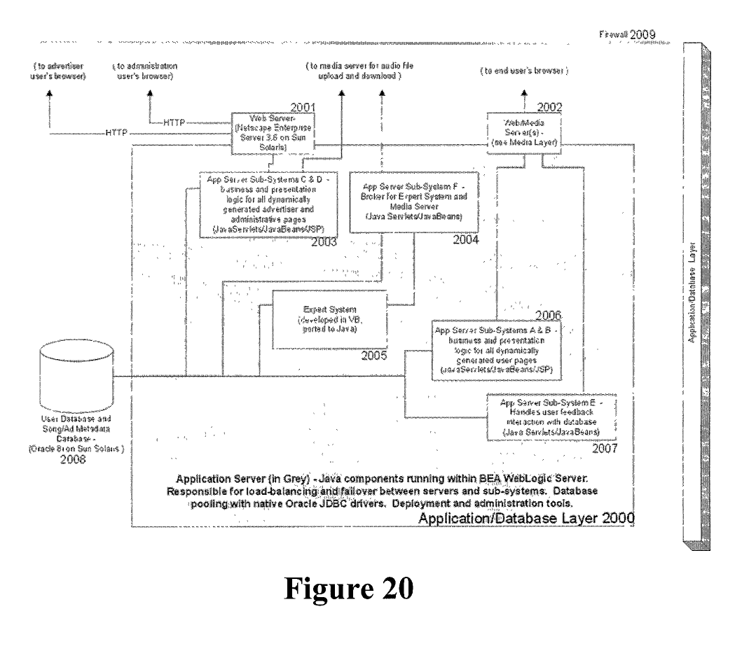

While FIGS. 1 through 19 illustrate a logical information gathering and content delivery flow, FIGS. 20 through 23 provide an illustration of a software architecture used in the present invention. FIG. 20 illustrates functions performed by portions of a server. FIG. 22 provides an alternative illustration of Application/Database Layer Components illustrated in FIG. 20. FIG. 22 further illustrates the interaction of Application/Database Layer Components 2210 with Web/Media Layer 2220, and a client or clients.

FIG. 22 illustrates interactions between PMP devices or other downstream clients (illustrated as Portable Media Player 2202), clients (illustrated as User PC 2204), and server software (illustrated as Web/Media Layer 2220 and Application/Database Layer 2210). As a user interacts with a client, data may be transmitted from User PC 2204 to Web Server 2223 through Firewall 2222. Examples of user/client interaction may include requesting additional content information, indicating a desire to purchase content, entering or maintaining personal information or content genre preferences, and other functions provided by a client.

Firewall 2222 may act as a gateway through which data passes from a client to Web/Media Layer 2220, thus helping to protect information stored in Web/Media Layer 2220. Firewall 2222 may transmit received data to Local Director 2223. Local Director 2223 may consist of one or more applications that can direct information requests sent by clients to Web Server(s) 2224. Local Director 2223 may also balance the number of sessions handled by each web server, and automatically reroute requests away from nonfunctioning web servers.

Web Server(s) 2224 may receive data from Local Director 2223, parse received information into pieces, and route the pieces to an appropriate application for processing. Web Server(s) 2224 may consist of one or more World Wide Web servers. Web Server(s) 2224 may transmit content received from Secured audio files 2225 to a client through Firewall 2222.

Secured audio files 2225 can act as an interface between Web Server(s) 2224 and Audio Streaming/Download Server(s) 2226. Secured audio files 2225 may encrypt content from Audio Streaming/Download Server(s) 2226 and add additional content information before passing content to Web Server(s) 2224. Secured audio files 2225 may consist of software or hardware running on a single server or software or hardware running on multiple servers.

Audio Streaming/Downloading Server(s) 2226 can provide Web Server(s) 2224 with access to content stored in Media Database 2228. Media Database 2228 may consist of one or more database servers. Data stored in Media Database 2228 may be distributed among database servers (“striped”), may be housed on multiple database servers (“mirrored”), or may be both striped and mirrored. Media Database 2228 can contain various forms of content, including, but not limited to, audio, video, and still image files. Media Database 2228 may also house content attributes, such as, but not limited to, the duration or size of particular content, content descriptions, content genre(s), content author(s), and content creation date.

Content may be stored in Media Database 2228 using a combination of compression and encryption technologies. Media Database 2228 may store content as files external to a database, or content may be stored internal to a database.

Content can be delivered from Media Database 2228 to Audio Streaming/Downloading Server(s) 2226. Audio Streaming/Downloading Server(s) 2226 may deliver content to Web Server(s) 2224 in a format chosen by a user. Data delivery formats may include discrete file transmissions, data streams, or combinations of discrete files and data streams. Audio Streaming/Downloading Server(s) 2226 may also adjust content quality, compression techniques, or other content aspects to provide quality content consistent with user preferences and available data transmission methods. For example, Audio Streaming/Download Server(s) 2226 may provide lower resolution audio or video to a user accessing the present invention over a low bandwidth connection, such as a V.90 (56 Kbps) or V.42 (33.6 Kbps) modem connection, so that smooth, seamless content may be experienced.

Web Server(s) 2224 may also transmit data to Application/Database Layer 2210 through Playlist creation & user registration/preference pages 2229. Data transmitted to Application/Database Layer 2210 may include user information, such as names, addresses, telephone numbers, and the like, as well as preference information, including, but not limited to, content preferences and content purchase information. FIG. 20 provides a more detailed illustration of Application Layer 2210, including recommended applications and programming languages for individual components.

FIG. 20 illustrates Application/Database Layer 2210 of FIG. 22 as Application/Database Layer 2000. Application/Database Layer 2000 performs several functions, including, but not limited to, providing an interface to User Database and Song/Ad Metadata Database (“User Database”) 2008 for authorized users (Administration PC 2205 and Record Label/Advertisers PC 2206 of FIG. 22), providing Web Server(s) 2224 of FIG. 22 with an interface to User Database 2008, and creating new content playlists based on content genre preferences.

Web Server 2001 can provide administrators and advertisers with an interface to user data. Web Server 2001 may make user data available by requesting data in specific formats from App Server Sub-Systems C & D (“Advertiser Business and Presentation Logic”) 2003. Advertiser Business and Presentation Logic 2003 may generate dynamic web pages based on requested user data, which may then be provided to advertisers and administrators through Web Server 2001. User data available to advertisers may include, but is not limited to, a filterable list of users to whom content was delivered, and a filterable list of content reviews. Administrators may access and/or modify all data stored in User Database 2008.

Application/Database Layer 2000 may also create new playlists based on content genre preferences. When a client requests a new playlist, a request may be sent to App Server Sub-System F (“Media Server Broker”) 2004 to create a playlist for a given user. Media Server Broker 2004 may pass a playlist request to Expert System 2005. Expert System 2005 may interface with User Database 2008 and request a content list based on specific criteria, such as, but not limited to, user content genre preferences, device requesting content, and genre(s) into which content belongs. Expert System 2005 may create a playlist based on information returned from User Database 2008. Playlists may be sent to a client through Media Server Broker 2004.

Web/Media Server 2002 may provide Web/Media Layer 2220 of FIG. 22 access to User Database 2008. App Server Sub-Systems A and B (“User Business Logic”) 2006 may provide access to personal information, such as user names, passwords, addresses, and the like. App Server Sub-System E (“User Feedback”) 2007 may provide access to user content reviews, content purchase requests, content information requests, and other such information stored in User Database 2008.

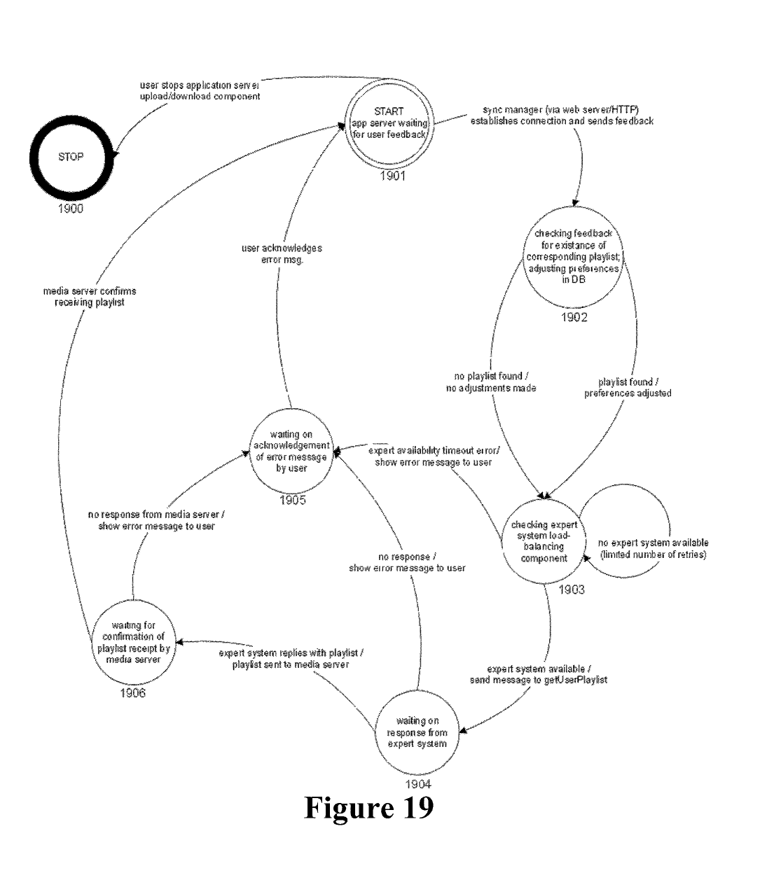

An alternative illustration of the process by which a playlist may be created is illustrated by FIG. 19. In Block 1901, user feedback may have been recently uploaded from a client. In Block 1902, feedback may be matched to a previously transmitted playlist. If a previous playlist cannot be found or an incorrect reference to a playlist exists, processing may proceed to Block 1903. If a previous playlist can be found and feedback corresponds to that playlist, content genre preferences may be adjusted and processing may continue with Block 1903.

Block 1903 may attempt to contact Expert System 2005 of FIG. 20 to retrieve a new playlist. If Expert System 2005 does not respond, a client may attempt to contact Expert System 2005 a preset number of times. If Expert System 2005 does not respond within a preset number of communications attempts, an error message may be presented to a user (Block 1905), and processing may loop to Block 1901.

If Expert System 2005 does reply (Block 1904), a playlist may be transmitted from Application/Database Layer 2210 of FIG. 22 to Web/Media Layer 2220 of FIG. 22, and a confirmation may be requested. If no confirmation is received (Block 1906), an error message may be presented to a user (Block 1905), and processing may loop to Block 1901. If confirmation is received, a playlist has been created and passed to Web/Media Layer 2220 to be delivered to a client, and processing may loop to Block 1901.

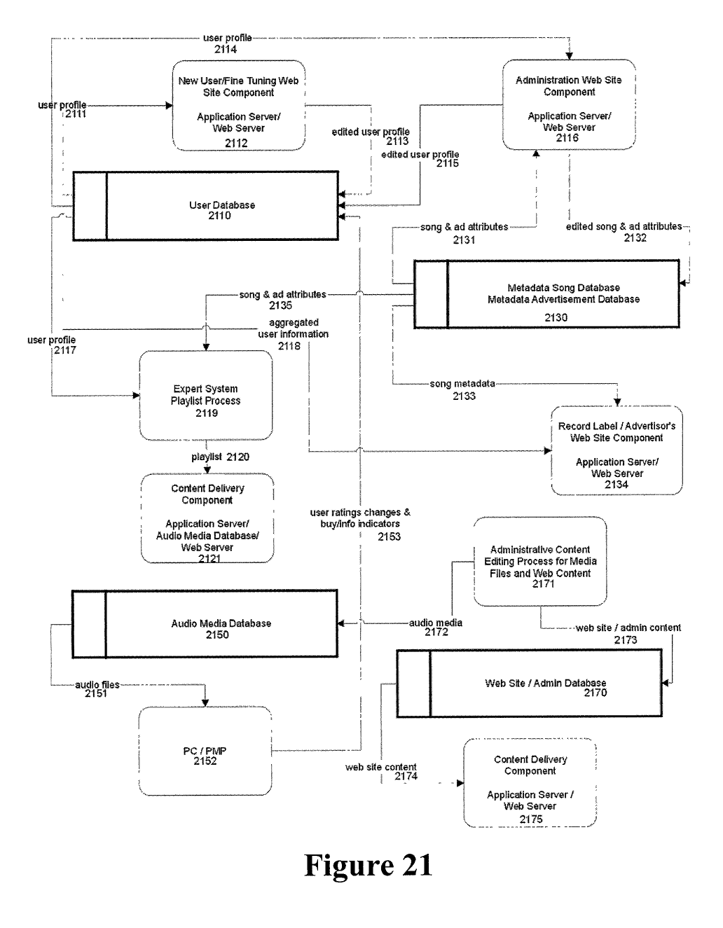

FIG. 21 provides an alternative architectural illustration of the present invention. User Database 2110 may contain user-specific information, such as, but not limited to, names, addresses, and content genre preferences. Users may edit information stored in User Database 2110 through New User/Fine Tuning Web Site Component 2112. Edited information may be stored in User Database 2110.

User Database 2110 may supply user information to Administration Web Site Component 2116. Administration Web Site Component 2116 may allow an administrator to edit user information, as well as song & ad attributes 2131 obtained from Metadata Song Database 2130. Edited user information may be stored in User Database 2110, and edited song and advertising attributes may be stored in Metadata Song Database 2130.

User Database 2110 may also supply user information to Expert System Playlist Process 2119. Expert System Playlist Process 2119 may use user profile 2117 and song & ad attributes 2135 to customize playlist 2120 for a specific user or group of users. Playlist 2120 may be sent to Content Delivery Component 2121, which in turn may use a playlist to determine content to be delivered to a client.

Record Label/Advertiser's Web Site Component 2134 may allow an advertiser or content provider to view aggregated user information 2118 as well as song metadata 2133. Content providers and advertisers may not edit user information or song metadata. In addition, content providers and advertisers may not have access to all data stored in User Database 2110 and/or Metadata Song Database 2130.

Administrative Content Editing Process 2171 may allow an administrator to add, edit, and/or remove content from Audio Media Database 2150. Administrative Content Editing Process 2171 may also allow an administrator to add, edit, and/or remove data stored in Web Site/Admin Database 2170. Web Site/Admin Database 2170 may contain images and/or text that may be used to create web sites through which users, advertisers, content providers, and administrators access the present invention. Changing data stored in Web Site/Admin Database 2170 may affect the look and feel of web-based user interfaces provided by the present invention. Such web-based interfaces may be provided through web site content 2174 and Content Delivery Component 2175.

Audio Media Database 2150 may contain content to be provided by the present invention. Audio Media Database 2150 may store content internally, or content may be stored external to a database, with pointers or other such references stored in a database. A client receiving playlist 2120 may request content (audio files 2151) to be delivered to a device (PC/PMP 2152).

PC/PMP 2152 may allow a user to experience content. PC/PMP 2152 may also provide content genre preference changes and information requests (user ratings changes & buy/info indicators 2153) to User Database 2110.

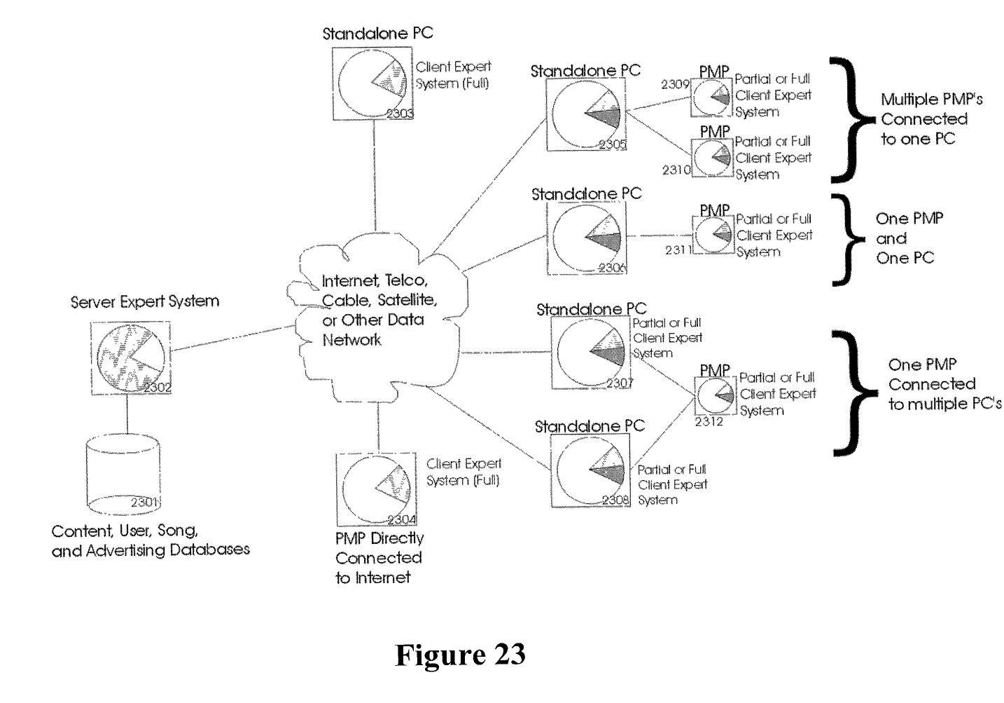

FIG. 23 is a block diagram illustrating the multi-level Expert System employed by the present invention. The Expert System may perform many functions, including, but not limited to, scheduling content downloads, selecting content to be experienced by a user, and managing content stored on a device.

The Expert System may consist of server and client portions. A server portion may run on the same device as a client, or on separate servers. Clients or servers or both may be distributed. The server portion of an Expert System (“Expert System Server”) may exist as part of the Application Database Layer, illustrated in FIGS. 20 and 22. The Expert System Server (Block 2302 of FIG. 23) may generate lists of content to be delivered to a client. Content may be selected based on factors such as, but not limited to, user preferences, user group membership, and content provider specifications.

As previously discussed, users may indicate preferences for various content genres when configuring an account. Users may also join previously existing user groups to simplify content selection, and/or allow for more eclectic content composition. Users may also rate individual content while content is experienced, and users may rate previously experienced content. User ratings may include an option to restrict the frequency with which content appears on a playlist. Content ratings may be stored in a database (illustrated as Block 2301 in FIG. 23), and used by the Expert System Server when selecting content for an individual user or for a group of users.

Users may also specify rules governing selection of content for use in playlists. Examples of user rules may include, but are not limited to, defining a ratio of new content to old content in a playlist, and defining a tolerance for an introduction of content from other genres. If a user joins a user group, such preferences may be configured group-wide, and may only be accessible to an administrator.

Content providers, including advertisers, content creators, content distributors, and others, may also place restrictions on content use or indicate other parameters that may affect playlist content selection of content for a playlist, or the order in which content appears within a playlist. The following are examples of limitations content providers may place; examples are included for illustrative purposes, and are not intended to limit the present invention. Content providers may require or limit delivery of content created by a particular artist to a user, set of users, user group, or set of user groups. Content providers may also limit delivery to or require delivery at a specific frequency or over a frequency range. Content providers may also restrict where their content appears with respect to other content. Such restrictions may include, but are not limited to, preventing or requiring content from a particular artist to appear near or next to content of another specific artist, advertiser, or other content provider.

The Expert System Server may also apply other rules when selecting and/or ordering content for a playlist. Such rules may be customizable by users, content providers, or administrators. Examples of rules, provided for illustration and not intended to limit the present invention, include not scheduling content of a particular genre, range of genres, rating, or range of ratings, for more than a specific period; always starting and/or finishing a playlist with content of a particular minimum or maximum rating; and always starting and/or finishing a playlist with content of a particular genre or range of genres.

Multiple playlists may also be created for a user. Users may select from a set of playlists stored on a device through a client portion of the Expert System (“Expert System Client”). An Expert System Client may perform various functions, including, but not limited to, requesting content from an Expert System Server or directly from a server acting as part of the present invention, controlling content storage, and distributing content stored on a device to downstream devices.

An Expert System Client may monitor system resources and delete from a device any content no longer needed. An Expert System Client may select content to be deleted based on user preference and playlist information. As an example, an Expert System Client may not delete content highly desirable to a user if that content appears frequently in a playlist.

An Expert System Client may also request new content from a server or from an Expert System Server if content available on a device drops below a customizable level. In the event restricted content is no longer available on a device, or such content is selected by a user, an Expert System Client may allow a user to experience content purchased by a user. An Expert System Client may generate a playlist of locally stored content based on rules similar to those described for the Expert System Server.

In an alternative embodiment, the present invention may work without a central server. Rather, PMP's, PC's, and other devices can communicate directly with one another and exchange content, ratings information, user preferences, and other information.

While the preferred embodiment and various alternative embodiments of the invention have been disclosed and described in detail herein, it may be apparent to those skilled in the art that various changes in form and detail may be made therein without departing from the spirit and scope thereof. Specifications or other language contained in F associated with this application should not be construed as limiting the present invention, but are included to illustrate the best mode contemplated at the time of filing.

We claim as our invention:

1. A custom content presentation system through which users can influence presented content, comprising:
a client such as a PC, PMP, or other device capable of stimulating human senses which is capable of receiving data from and conveying data to a server;
a server which conveys, receives, and stores data;
a content rating and information request system; and
a server-based reporting tool.

2. The system of claim 1 in which data stored by said server includes content, content attributes, and content reviews.

3. The system of claim 1 in which data conveyed from said server includes content and content information.

4. The system of claim 1 in which said client acts as a server, thereby providing content-related information stored thereon to other devices.

5. The system of claim 1 in which said content rating system allows a user to rate content as or after it is experienced.

6. The system of claim 1 in which said device has buttons or other interface elements that allow a user to provide feedback concerning various content, enter preference information, or otherwise interact with content or with a server.

7. The system of claim 1 in which data conveyed from said server contains proprietary or restricted content that is marked as such, and which said client may refuse to process if certain restrictions are not met.

8. The system of claim 1 in which said server conveys only data of interest to a user, as determined by user feedback and user preferences.

9. The system of claim 1 in which said information request system allows a user to purchase or indicate a desire to purchase content before, during and after it is experienced.

10. The system of claim 1 in which user feedback and information requests are immediately sent to a server through a wireless or wired communications medium.

11. The system of claim 1 in which user feedback and information request are stored on a device until said device can communicate with a server, at which time said feedback and information requests are conveyed to a server.

12. The system of claim 1 in which said reporting tool provides reports to content authors, advertisers, and other interested parties which contain average content ratings, content popularity indexes, content information requests, genre-based content preferences, and other information derived from data stored in a server.

13. A method for individualized content distribution comprising the steps of:
selecting content based on user preferences, content author or publisher preferences;
preparing said content, including the addition of ownership, authorship, and other digital rights information, and content compression or encryption;
conveying said content to a PMP, PC, or other device from which said content may be experienced; and
removing said content after a length of time, number of experiences, or other event.

14. The method of claim 13 wherein said user preferences are based on ratings gathered substantially contemporaneous with a user's experiencing said content.

15. The method of claim 13 wherein content preferences are entered by a user prior to content selection, and where such preferences are modified as content is experienced and user ratings are received.

16. The method of claim 13 wherein said content includes advertisements which are targeted at a particular individual or group of individuals based on content preferences, frequency with which content is purchased through the present invention, geographic region in which a user resides, or other demographic information.

17. The method of claim 13 wherein said digital rights information may be used to restrict access to content on an individual-by-individual, device-by-device, or group-by-group basis.

18. The method of claim 13 wherein said user preferences include the option to refuse certain content types, such as advertisements or full-motion video, and content genres.

19. The method of claim 13 wherein said content compression includes down-sampling content to reduce such content's file size or conveyance needs.

20. The method of claim 13 wherein said conveyance may be achieved by a means set forth in user preferences.

21. The method of claim 13 wherein said content may be altered, such as resizing text or graphical information, down-sampling audio or video files, or other alterations, to match device capabilities or to meet user specifications.

22. The method of claim 13 wherein said conveyance may be achieved by a means appropriate to a specific device, such as wired or wireless communications or removable media.

23. The method of claim 13 wherein said content may be removed based on digital rights management or other content attributes associated with a specific content.

24. The method of claim 23 wherein said content removals are also controlled by user preferences and user ratings such that popular content is maintained by a device, thus reducing storage, conveyance, and related needs.

25. The method of claim 13 wherein said content is conveyed from a server to a client by transmitting said content as a continuous data stream.

26. The method of claim 13 wherein said content is conveyed from a server to a client by a server storing said content on removable media and transferring said media to a client.

27. The method of claim 13 wherein said content is conveyed from a server to a client by transmitting said content as discrete files.

28. The method of claim 13 wherein said content is conveyed from a server to a client as a combination of discrete file transfers and streamed data.

29. A custom content presentation system through which users can influence presented content, comprising:
a client such as a PC, PMP, or other device capable of stimulating human senses which is capable of receiving data from and conveying data to a server;
a server which conveys, receives, and stores data;
a content rating and information request system; and
a server-based reporting tool;
wherein said server stores content, content attributes, and content reviews;
said server conveys some content information to a client along with said content;
users experience said content through a device;
users rate content during or after such content is experienced;
users request information about or indicate a desire to purchase content as it is experienced;
user ratings, information requests, and purchase requests are conveyed to a server; and
said user ratings and requests are used to select additional content for a client, and to generate usage statistics and other information for content creators.

30. A method for individualized content distribution comprising the steps of:
selecting content based on user preferences, content author or publisher preferences;
preparing said content, including the addition of ownership, authorship, and other digital rights information, and content compression or encryption;
conveying said content to a PMP, PC, or other device from which said content may be experienced; and
removing said content after a length of time, number of experiences, or other event;
the method further comprising the steps of a user:
specifying content preferences in a web page or other machine-readable format;
said content selected based on such preferences;
selected content processed for conveyance and conveyed to a device;
said content experienced by said user;
said user rating said content;
all or a portion of said content at or above a certain rating level being maintained on a device, while some portion of said content may be removed from a device once said content has been experienced; and
content remaining on a device is only experienced after approval from a server, content author, or content provider.
